(19) United States
(12) Patent Application Publication
(10) Pub. No.: US 2020/0357348 A1
(43) Pub. Date: Nov. 12, 2020

(54) IMAGE DISPLAY APPARATUS AND IMAGE DISPLAY METHOD

(71) Applicant: SONY CORPORATION, Tokyo (JP)

(72) Inventor: Atsuhiro CHIBA, Tokyo (JP)

(73) Assignee: Sony Corporation, Tokyo (JP)

(21) Appl. No.: 16/095,227

(22) PCT Filed: Mar. 17, 2017
(86) PCT No.: PCT/JP2017/010922

§ 371 Date: Oct. 19, 2018

(30) Foreign Application Priority Data
Apr. 28, 2016 (JP) 2016-090213

(51) Int. Cl. G09G 3/34; G09G 3/20

(52) U.S. Cl. CPC G09G 3/3433; G09G 2310/0275; G09G 3/2022

(57) ABSTRACT

An image display apparatus of the present disclosure includes: a light modulator that performs light modulation on the basis of data of a bit plane for each grayscale bit; and a transfer controller that divides the data of the bit plane into data of a plurality of groups and transfers the data of the respective groups to the light modulator at shifted transfer timings, the shifted transfer timings being sequentially shifted only by a predetermined shift amount corresponding to a subframe period of a least significant grayscale bit multiplied by a predetermined integral.

### TECHNICAL FIELD

The present disclosure relates to an image display apparatus and an image display method.

### BACKGROUND ART

A digital image display apparatus in which display states of an image are basically allowed to take only two states of on and off (light emission (bright)/no-light emission (dark)) has been in practical use. In the digital image display apparatus, a DMD (Digital Micromirror Device) or a PDP (Plasma Display Panel), for example, is used as a light modulator. Basically, unlike an analog-type display apparatus, the digital image display apparatus is not able to perform continuous grayscale expression and thus performs the grayscale expression in multiple steps. A method thereof includes a PWM (Pulse Width Modulation; pulse width modulation) system, for example. This system is a system that performs the grayscale expression by maintaining luminance of a light source at a fixed magnitude and varying a width of a light emission time in accordance with the luminance.

### CITATION LIST

### Patent Literature

PTL 1: Japanese Unexamined Patent Application Publication No. 2001-343950

PTL 2: Japanese Unexamined Patent Application Publication (Published Japanese Translation of PCT Application) No. JP2000-510252

### SUMMARY OF THE INVENTION

In a digital image display apparatus, a band necessary for data transfer of image data to a light modulator increases with higher resolution and higher grayscale, and an algorithm for the data transfer may be complicated to cope with this.

It is desirable to provide an image display apparatus and an image display method that make it possible to suppress the band necessary for the data transfer and to make the algorithm for the data transfer relatively simple.

An image display apparatus according to an embodiment of the present disclosure includes: a light modulator that performs light modulation on the basis of data of a bit plane for each grayscale bit; and a transfer controller that divides the data of the bit plane into data of a plurality of groups and transfers the data of the respective groups to the light modulator at shifted transfer timings, the shifted transfer timings being sequentially shifted only by a predetermined shift amount corresponding to a subframe period of a least significant grayscale bit multiplied by a predetermined integral.

An image display method according to an embodiment of the present disclosure includes: performing light modulation by a light modulator on a basis of data of a bit plane for each grayscale bit; and dividing the data of the bit plane into data of a plurality of groups and transferring the data of the respective groups to the light modulator at shifted transfer timings, the shifted transfer timings being sequentially shifted only by a predetermined shift amount corresponding to a subframe period of a least significant grayscale bit multiplied by a predetermined integral.

In the image display apparatus or the image display method according to the embodiment of the present disclosure, the data of the bit plane is divided into the data of the plurality of groups, and the data of the respective groups is transferred to the light modulator at the shifted transfer timings that are sequentially shifted only by the predetermined shift amount corresponding to the subframe period of the least significant grayscale bit multiplied by the predetermined integral.

According to the image display apparatus or the image display method of the embodiment of the present disclosure, the data of the bit plane is divided into the data of the plurality of groups, and the data of the respective groups is transferred to the light modulator at the shifted transfer timings that are sequentially shifted only by the predetermined shift amount corresponding to the subframe period of the least significant grayscale bit multiplied by the predetermined integral, which thus makes it possible to suppress the band necessary for data transfer and to make the algorithm for data transfer relatively simple.

It is to be noted that effects described here are not necessarily limited and may include any of effects described in the present disclosure.

### BRIEF DESCRIPTION OF DRAWINGS

FIG. 1 is a block diagram illustrating a configuration example of an image display apparatus of a PWM system.

FIG. 2 is a block diagram illustrating a configuration example of a data formatter in the image display apparatus illustrated in FIG. 1.

FIG. 3 is an explanatory diagram illustrating a principle of grayscale expression of the PWM system.

FIG. 4 is an explanatory diagram illustrating an example of a data transfer technique according to a comparative example.

FIG. 5 is an explanatory diagram illustrating a first example of division of a display region in an image display apparatus according to a first embodiment of the present disclosure.

FIG. 6 is an explanatory diagram illustrating a first example of a data transfer system in the image display apparatus according to the first embodiment of the present disclosure.

FIG. 7 is an explanatory diagram illustrating a second example of the data transfer system.

FIG. 8 is an explanatory diagram illustrating a second example of the division of the display region.

FIG. 9 is an explanatory diagram illustrating a third example of the data transfer system.

FIG. 10 is an explanatory diagram illustrating a fourth example of the data transfer system.

FIG. 11 is an explanatory diagram illustrating a first example of a data transfer start timing.

FIG. 12 is an explanatory diagram illustrating a second example of the data transfer start timing.

FIG. 13 is an explanatory diagram illustrating a list of minimum shift amounts between transfer timings.

### MODES FOR CARRYING OUT THE INVENTION

In the following, some embodiments of the present disclosure are described in detail with reference to the drawings. It is to be noted that the description is given in the following order.

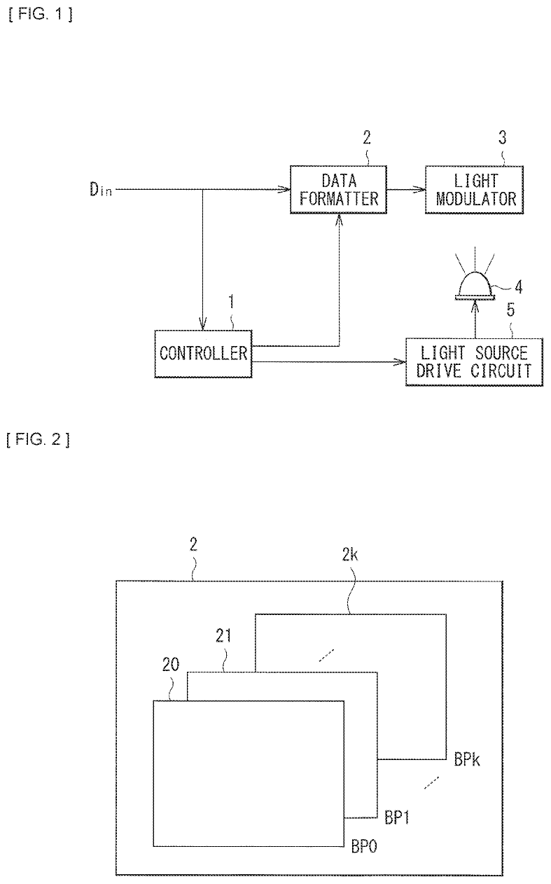

### 0. Comparative Example (FIG. 1 to FIG. 4)

### 0.1 Overview of Image Display Apparatus of PWM System

### 0.2 Issue

### 1. First Embodiment

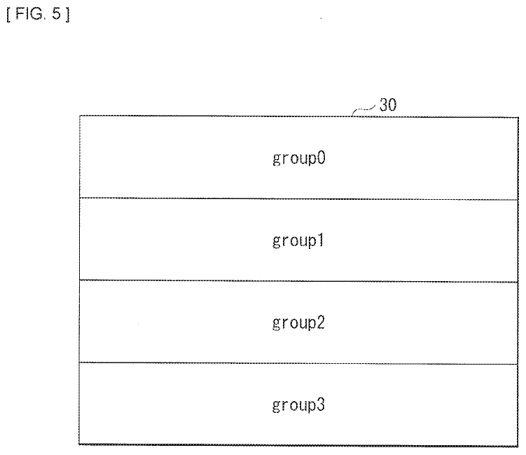

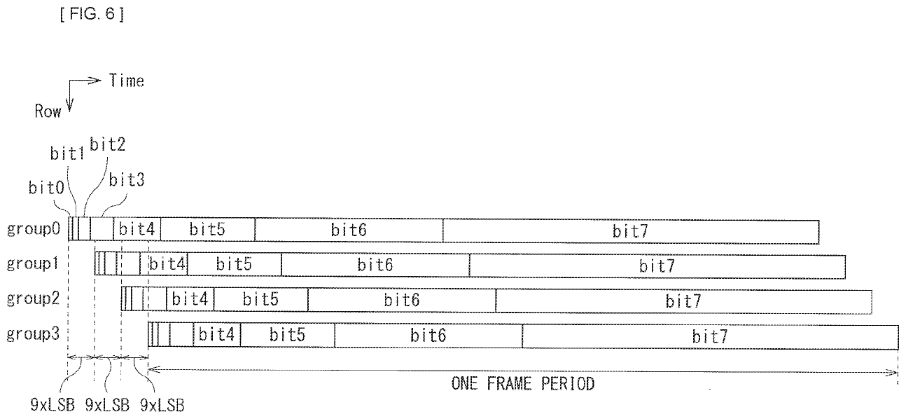

### 1.1 First Example of Data Transfer System (FIG. 5 to FIG. 6)

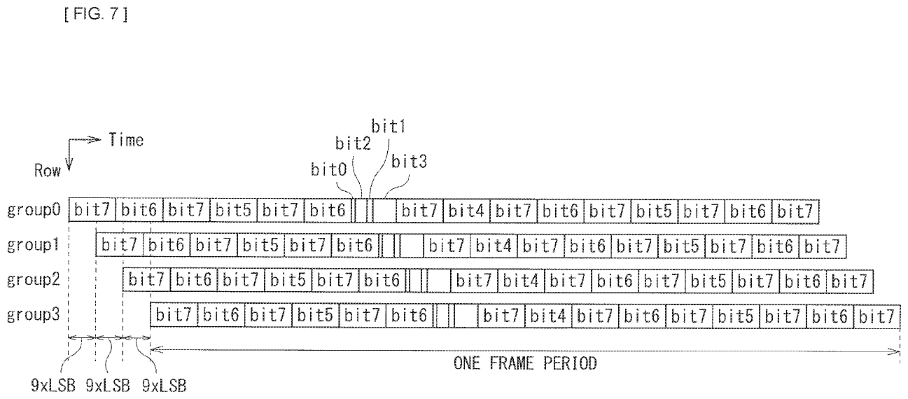

### 1.2 Second Example of Data Transfer System (FIG. 7)

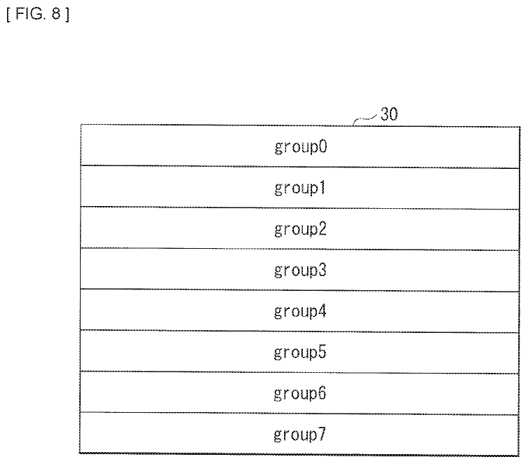

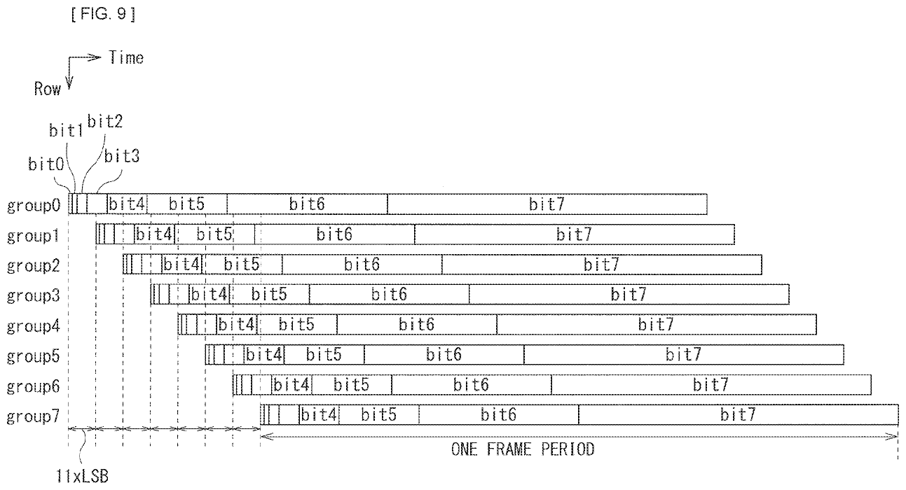

### 1.3 Third Example of Data Transfer System (FIG. 8 to FIG. 9)

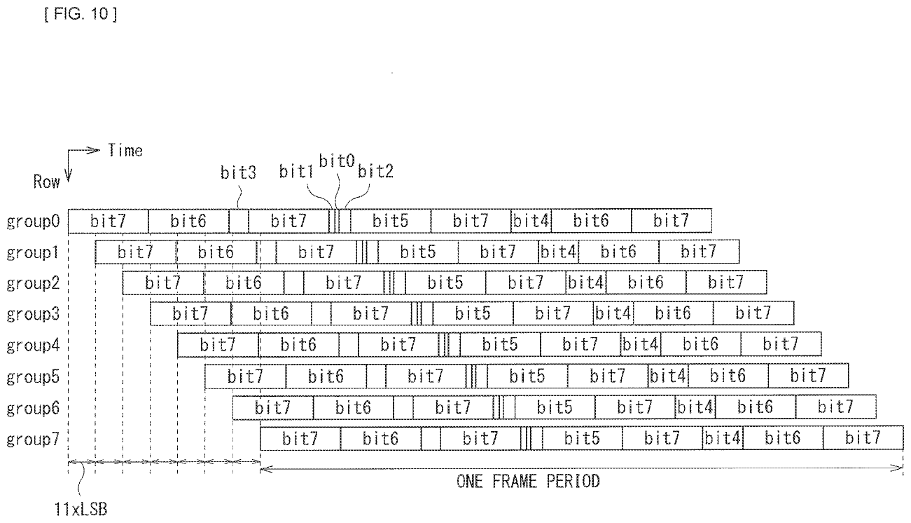

### 1.4 Fourth Example of Data Transfer System (FIG. 10)

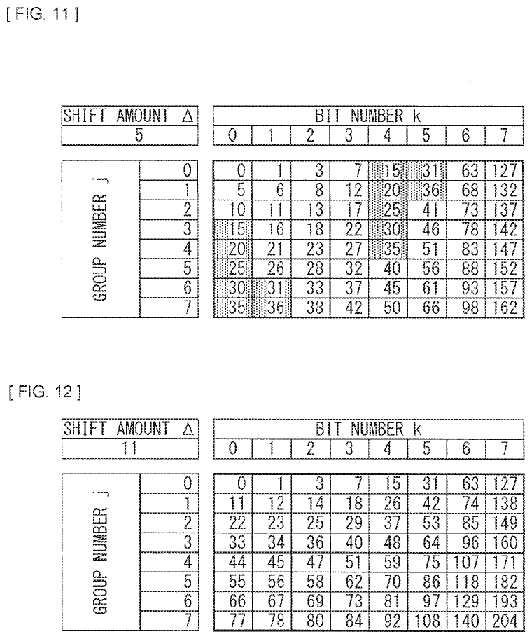

1.5 Method of Calculating Shift Amount between Transfer Timings (FIG. 11 to FIG. 13)

### 1.6 Effects

### 2. Other Embodiments

### 0. Comparative Example

### [0.1 Overview of Image Display Apparatus of PWM System]

FIG. 1 illustrates a configuration example of an image display apparatus of a PWM system. The image display apparatus includes a controller 1, a data formatter 2, a light modulator 3, a light source 4, and a light source drive circuit 5.

The light source drive circuit 5 drives the light source 4 in accordance with control of the controller 1.

The data formatter 2 generates data of a bit plane for each grayscale bit to be described later from inputted image data Din in accordance with the control of the controller 1. As illustrated in FIG. 2, the data formatter 2 includes a plurality of image memories 20, 21, . . . , and 2k. The image memory 20 holds data of a bit plane BP0 for a grayscale bit B0, for example. The image memory 21 holds data of a bit plane BP1 for a grayscale bit B1, for example. The image memory 2k holds data of a bit plane BPk for a grayscale bit Bk, for example.

In the image display apparatus that performs grayscale expression with the PWM system, the light modulator 3 is continuously irradiated with light having fixed luminance from the light source 4. The light modulator 3 controls modulation of the light into two states, that is, bright and dark states for each pixel, in accordance with luminance of an image to be displayed. At this time, as light modulation control, the light modulator 3 performs pulsed on (light emission)/off (non-light emission) control on light reaching an image display surface. Then, the light modulator 3 varies a pulse width of the light by varying a timing of switching on/off for each pixel to perform the grayscale expression. The image is displayed in multistep grayscale by irradiating the image display surface with the thus-modulated light.

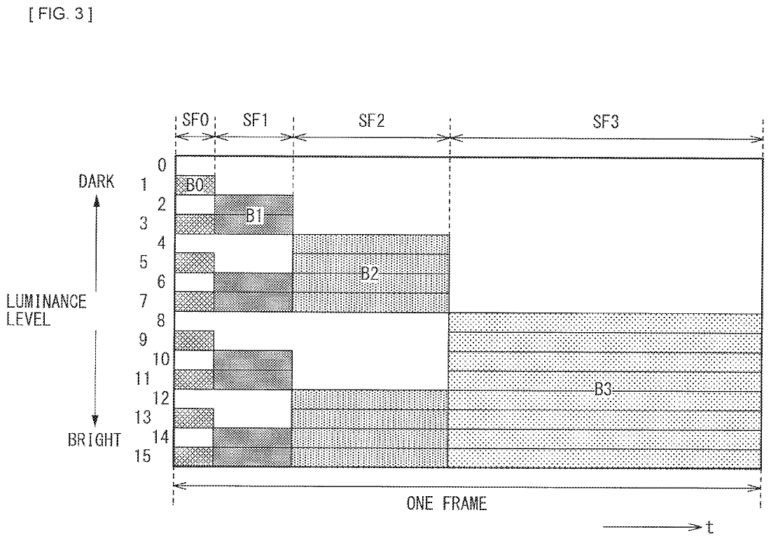

In the following, a principle of the grayscale expression of the PWM system is described more specifically with reference to FIG. 3. It is to be noted that unless otherwise noted, “light emission” hereinafter refers to a state in which the light from the light source 4 is able to reach the image display surface via the light modulator 3, and “non-light emission” refers to a state in which the light is unable to reach the image display surface. FIG. 3 illustrates an example of the modulation control of the luminance in one frame period of an image signal. In FIG. 3, a vertical direction represents a luminance level (grayscale level) and a horizontal direction represents time t. FIG. 3 illustrates a case where grayscale data per pixel is 4 bits and the grayscale expression of 16 grayscales is performed. Moreover, a hatched region in the figure represents that the region is in a light emission state and other region that is not hatched represents that the other area is in a non-light emission state.

It is possible to express an image of the 16 grayscales by combining at least four kinds of images that are different in luminance, within a predetermined period of time (normally, one frame). That is, in a case where the 16 grayscales are expressed, first, for each pixel, the luminance is quantized to four grayscale bits, for example. Then, image data of the one frame, for example, is expressed by a combination of four kinds of image data that are weighted with each grayscale bit. At this time, a collection of the image data for each grayscale bit is typically referred to as a “bit plane”. The bit plane is an information plane of the luminance for each grayscale bit.

In FIG. 3, the one frame is divided into four subframes SF0 to SF3. In FIG. 3, data of the four grayscale bits B0 to B3 is respectively displayed in sequence in the subframe periods SF0 to SF3. Time lengths of the respective subframes are weighted to SF0:SF1:SF2:SF3=1:2:4:8, corresponding to the weights of the grayscale bits B0 to B3. Accordingly, in terms of the time length, the data of the grayscale bit B3, for example, is displayed eight times longer than the data of the grayscale bit B0. Therefore, the luminance of the light source 4 here is fixed, which causes the data of the grayscale bit B3 to be displayed at a luminance level that is eight times higher than the data of the grayscale bit B0. The image of the one frame is thus divided by the subframe periods and displayed, thereby performing the grayscale expression.

### [0.2 Issue]

The image display apparatus causes each pixel to emit light in a predetermined subframe period, and thus the data of each bit plane is transferred from the data formatter 2 to the light modulator 3 in a predetermined period that is provided in advance of each subframe period. That is, all the data of the bit plane BP0 of the grayscale bit B0, for example, is fed from the data formatter 2 to the light modulator 3 in the predetermined period that is provided earlier than a period of the subframe SF0. Simultaneously with start of the subframe SF0, the light modulator 3 performs switching of the on/off state concurrently for all the pixels on the basis of the data of the bit plane BP0 and holds this state during the period of the subframe SF0. Moreover, all the data of the bit plane BP1 of the grayscale bit B1, for example, is fed from the data formatter 2 to the light modulator 3 within the predetermined period that is provided earlier than a period of the subframe SF1. Simultaneously with start of the period of the subframe SF1, the light modulator 3 performs the switching of the on/off state concurrently for all the pixels on the basis of the data of the bit plane BP1 and holds this state during the period of the subframe SF1. Subsequently, the data of the bit plane BP2 of the grayscale bit B2 and the data of BP3 of the grayscale bit B3 are similarly transferred sequentially from the data formatter 2 to the light modulator 3 in predetermined periods provided earlier than periods of the subframes SF2 and SF3. The image display apparatus repeats such control for each frame.

Therefore, it is necessary that a transfer period during which the data of the bit planes is transferred be at least within the period of the subframe SF0 of the grayscale bit B0. The grayscale bit B is a least significant grayscale bit (LSB). In FIG. 3, for example, in a case where the one frame is 1/60 seconds, the period of the subframe SF0 is 1/60× 1/15=1.1 milliseconds. Moreover, for example, in a case of a time-division system that performs grayscale expression of 256 grayscales with 8-bit grayscale data and performs color display while switching the light source 4 of red, green, and blue at high speed, the subframe period of the LSB is 1/(60×3)× 1/255=21.79 microseconds. The red, green and blue are three primary colors of light.

Then, it is necessary to transfer all the data of the bit plane BP1 at least within this subframe period SF0 of the LSB; therefore, the transfer rate of the data to be transferred from the data formatter 2 to the light modulator 3 reaches (1920×1080)/21.79=95.2 Gbps, for example, in a case of a full HD image having a resolution of 1920×1080. As described above, there is an issue that in particular, in image display of high resolution and high grayscale, a necessary data transfer band becomes high.

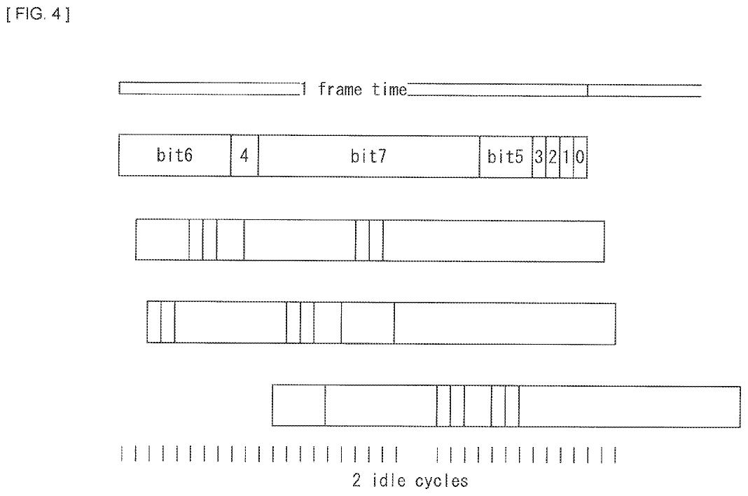

To solve the foregoing issue, as illustrated in FIG. 4, PTL2 (Japanese Unexamined Patent Application Publication (Published Japanese Translation of PCT Application) No. JP2000-510252), for example, there is proposed a technique of dividing bit planes into some groups and transferring data by changing a data arrangement sequence so as not to cause overlapping of data transfer periods of the bit planes in the respective groups.

In this data transfer technique, however, the data arrangement sequence (transfer sequence) or a transfer start timing differs among the divided groups. Thus, an algorithm for finding out a format that avoids overlapping of the transfer start timings, and transferring the data of the bit planes in a sequence in accordance with the format may be complicated.

### 1. First Embodiment

In the present embodiment, in the image display apparatus that performs grayscale expression with the PWM system, similarly to the comparative example described above, there is provided a data transfer system that reduces a transfer band of image data to be transferred from the data formatter 2 to the light modulator 3 and makes an algorithm for transferring the image data relatively simple.

It is to be noted that a configuration of the image display apparatus and a principle of grayscale expression according to the present embodiment may be substantially similar to those of the image display apparatus in FIG. 1.

In the image display apparatus according to the present embodiment, however, a display region of the light modulator 3 is spatially divided into a plurality of divided display regions, and the light modulator 3 performs light modulation on each divided display region. The data formatter 2 generates data of a bit plane for each grayscale bit from inputted image data Din in accordance with control of the controller 1. The data formatter 2 divides the data of the bit plane for each grayscale bit into data of a plurality of groups corresponding to the plurality of divided display regions and transfers the data of the respective groups to the light modulator 3 at shifted transfer timings with a data transfer system to be described later. The shifted transfer timings are sequentially shifted only by a predetermined shift amount. The controller 1 may be a transfer controller that controls a transfer timing of the data from the data formatter 2 to the light modulator 3. In the following, a specific example of the data transfer system of the present embodiment and a specific example of a method of calculating the shift amount between the transfer timings are described.

### [1.1 First Example of Data Transfer System]

FIG. 6 illustrates a first example of the data transfer system in the image display apparatus according to the present embodiment. As illustrated in FIG. 5, in the first example, a display region 30 of the light modulator 3 is spatially divided into four divided display regions and light modulation is performed on each of the divided display regions.

FIG. 6 illustrates the data transfer system in a case where grayscale expression of 256 grayscales is performed with 8-bit grayscale data with use of the technology achieved by the present disclosure. In FIG. 6, a k-th grayscale bit is denoted by bitk. This also applies to other examples to be described later. A ratio of the respective subframes from bit0 to bit7 is a ratio of powers of two of 1:2:4:8:16:32:64:128. In this system, bit planes are divided into four groups (group0 to group3) and the image data is transferred so as not to cause overlapping of the data transfer periods of the bit planes of the respective groups by shifting the transfer timings of the groups only by a period corresponding to nine times a subframe period of LSB (bit0).

With this system, a data amount to be transferred during the subframe period of the LSB is just ¼ of the bit plane. Thus, in a case of the color display of the time-division system with an image having full HD resolution, the data transfer band is (1920×1080/4)/21.79=23.8 Gbps. That is, it is possible to reduce the transfer band to ¼ of a data transfer band of 95.2 Gbps of a basic system in which the bit planes are not divided. Moreover, the data transfer sequence or the transfer start timing is the same among the divided groups, which thus makes it possible to make a circuit configuration for generation of a data signal from the image signal in accordance with this transfer format relatively simple.

### [1.2 Second Example of Data Transfer System]

FIG. 7 illustrates a second example of the data transfer system. In the second example, similarly to the foregoing first example, the display region 30 of the light modulator 3 is spatially divided into the four divided display regions, and light modulation is performed for each of the divided display regions, as illustrated in FIG. 5.

In this system, the subframe periods of three upper-order bits (bit5 to bit7) are divided into a plurality of short periods in one frame period. Then, the data of bit planes of the respective upper-order bits (bit5 to bit7) is dispersed among the plurality of short periods in the one frame period. Besides, similarly to the foregoing system in FIG. 6, the bit planes are divided into the four groups, and the image data is transferred so as not to cause overlapping of the data transfer periods of the bit planes of the respective groups by shifting the transfer timings of the respective groups only by the period corresponding to nine times the subframe period of the LSB (bit0).

With this system, similarly to the foregoing system in FIG. 6, it is possible to reduce the data transfer band to ¼ of the data transfer band of the basic system in which the bit planes are not divided. Moreover, by dividing the subframe periods of the upper-order bits and distributing the data of the bit planes of the upper-order bits, it is possible to suppress visual deterioration in image quality, which is referred to as a pseudo contour (or a false contour), specific to the PWM system and thus achieve an image display apparatus with high image quality.

It is to be noted that although FIG. 7 illustrates the example in which the subframe periods of the three upper-order grayscale bits (bit5 to bit7) are divided, the grayscale bits to be divided are not limited to this example. In each group, It is sufficient if a subframe period of at least one predetermined grayscale bit other than the least significant grayscale bit is divided into a plurality of periods in the one frame period, and the data of the bit plane of the predetermined grayscale bit is distributed among the plurality of periods and transferred to the light modulator 3.

### [1.3 Third Example of Data Transfer System]

FIG. 9 illustrates a third example of the data transfer system. In the third example, as illustrated in FIG. 8, the display region 30 of the light modulator 3 is spatially divided into eight divided display regions and the light modulation is performed for each of the divided display regions.

In this system, the bit planes are divided into eight groups (group0 to group7), and the image data is transferred so as not to cause overlapping of the data transfer periods of the bit planes of the respective groups by shifting the transfer timings of the respective groups only by a period corresponding to 11 times the subframe period of the LSB (bit0).

With this system, the data amount to be transferred during the subframe period of the LSB is just ⅛ of the bit plane. Thus, in the case of the color display of the time-division system with an image having full HD resolution, the data transfer band is (1920×1080/8)/21.79=11.9 Gbps. That is, it is possible to reduce the transfer band to ⅛ of the data transfer band of 95.2 Gbps of the basic system in which the bit planes are not divided. Moreover, the data transfer sequence or the transfer start timing is the same among the divided groups, which thus makes it possible to relatively easily configure the circuit for generation of a data signal from the image signal in accordance with this transfer format.

### [1.4 Fourth Example of Data Transfer System]

FIG. 10 illustrates a fourth example of the data transfer system. In the fourth example, similarly to the foregoing third example, the display region 30 of the light modulator 3 is spatially divided into eight divided display regions, and light modulation is performed for each of the divided display regions, as illustrated in FIG. 8.

In this system, the subframe periods of two upper-order bits (bit6 and bit7) are divided into a plurality of short periods in one frame period. Then, the data of bit planes of the respective upper-order bits (bit6 and bit7) is distributed among the plurality of short periods in the one frame period. Besides, similarly to the foregoing system in FIG. 9, the bit planes are divided into the eight groups, and the image data is transferred so as not to cause overlapping of the data transfer periods of the bit planes of the respective groups by shifting the transfer timings of the respective groups only by the period corresponding to 11 times the subframe period of the LSB (bit0).

With this system, similarly to the foregoing system in FIG. 9, it is possible to reduce the data transfer band to ⅛ of the data transfer band of the basic system in which the bit planes are not divided. Moreover, by dividing the subframe periods of the upper-order bits and distributing the data of the bit planes of the upper-order bits, it is possible to suppress visual deterioration in image quality, which is referred to as the pseudo contour (or the false contour), specific to the PWM system and thus achieve an image display apparatus with high image quality.

It is to be noted that although FIG. 10 illustrates the example in which the subframe periods of the two upper-order grayscale bits (bit6 and bit7) are divided, the grayscale bits to be divided are not limited to this example. In each group, it is sufficient if the subframe period of the at least one predetermined grayscale bit other than the least significant grayscale bit is divided into the plurality of periods in the one frame period, and the data of the bit plane of the predetermined grayscale bit is distributed among the plurality of periods and transferred to the light modulator 3.

### [1.5 Method of Calculating Shift Amount Between Transfer Timings]

In the following, a method of determining the shift amount between the transfer timings of the groups is described.

To transfer the image data so as not to cause overlapping of all of the data transfer periods of the bit planes of the respective groups, it is only necessary that a transfer start timing of arbitrary data does not overlap a transfer start timing of other data. It is possible to represent a transfer start timing T of the arbitrary data in a case where the data of the bit planes is transferred in sequence from the LSB, by the following expression.

T=jΔ+2^{k}−1 (1)

j=0, 1, 2, . . . , p−1

k=0, 1, 2, . . . , q−1

Here, Δ is a shift amount between the transfer timings of the respective groups (the shift amount is Δ times the subframe period of the LSB), j is a number of the divided group, k is a bit number of the grayscale bit, p is the division number of the bit plane, and q is the number of grayscale bits.

Moreover, it is necessary that a shift between the transfer start timing of a first divided group and the transfer start timing of a last divided group be less than one frame period; therefore, the shift amount Δ is limited as below.

Δ<(2^{q}−1)/(p−1) (2)

That is, an appropriate shift amount Δ in this technology is subject to a condition that the transfer start timings T, which are calculated by an expression (1), of the data of all the bit planes are different from one another and an expression (2) is satisfied.

As a specific example, FIG. 11 and FIG. 12 illustrate an example of the transfer start timing in a case where the division number p is equal to 8 and the number of bits q is equal to 8. FIG. 11 illustrates a result in a case where the shift amount Δ is equal to 5 (five times the LSB). In FIG. 11, the transfer start timings overlap at timings filled in gray, that is, seven points in one frame. In this manner, in a case where the division number p is equal to 8 and the number of bits q is equal to 8, some of the transfer start timings overlap in a case where the shift amount Δ is from 1 to 10.

FIG. 12 is an example of 11 times the LSB, and no transfer start timings overlap for the data of all of the bit planes. As described above, in a case where the division number p is equal to 8 and the number of bits q is equal to 8, the shift amount Δ that does not cause overlapping of the transfer start timings is 11, 13, 17, 19, . . . , and the minimum shift amount Δ is 11.

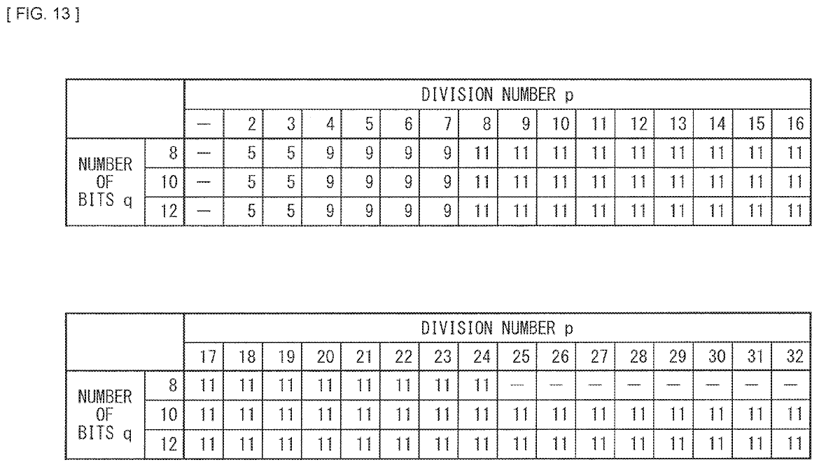

FIG. 13 is a list of the minimum shift amounts in a case where the division number is 2 to 32 and the number of bits is 8, 10, or 12. In a case where the bit number of q is equal to 8, it is not possible to satisfy the restriction of the expression (2) in a case where the division number p is equal to or larger than 25, thus resulting in no solution.

This technique allows for determination of the shift amount between the transfer timings of the groups with any number of bits and any division number.

From FIG. 13, in a case where the division number of the bit plane is 2 or 3, in particular, it is preferable to control the shift amount between the transfer timings to a period that is five times the subframe period of the LSB.

Moreover, in a case where the division number of the bit plane is not less than 4 and not more than 7, it is preferable to control the shift amount between the transfer timings to the period that is nine times the subframe period of the LSB.

Further, in a case where the division number of the bit plane is 8 or larger, it is preferable to control the shift amount between the transfer timings to the period that is 11 times the subframe period of the LSB.

### [1.6 Effects]

As described above, according to the embodiment, the data of the bit planes is divided into the data of the plurality of groups and the data of the respective groups is transferred to the light modulator 3 at shifted transfer timings that are sequentially shifted only by a predetermined shift amount corresponding to the subframe period of the LSB multiplied by a predetermined integral, which thus makes it possible to reduce the transfer band of the image data to be transferred from the data formatter 2 to the light modulator 3 and make the algorithm for transferring the image data relatively simple.

Moreover, according to the embodiment, reducing the data transfer band makes it possible to reduce the number of signals between the data formatter 2 and the light modulator 3 and to reduce the number of pads of a controller chip. As a result, it is possible to reduce power consumption of the data formatter 2. Further, by dividing the subframe periods of the upper-order bits and distributing the data of the bit planes of the upper-order bits in one frame period, it is possible to suppress visual deterioration in image quality, which is referred to as the pseudo contour (or the false contour), specific to the PWM system and thus achieve an image display apparatus with high image quality.

It is to be noted that the effects described herein are merely illustrative and non-limiting, and may further include other effects.

### 2. Other Embodiments

The technology achieved by the present disclosure is not limited to the description of the foregoing respective embodiments, and may be modified in a variety of ways.

For example, the technology may have the following configurations.

(1)

An image display apparatus, including:

a light modulator that performs light modulation on the basis of data of a bit plane for each grayscale bit; and

a transfer controller that divides the data of the bit plane into data of a plurality of groups and transfers the data of the respective groups to the light modulator at shifted transfer timings, the shifted transfer timings being sequentially shifted only by a predetermined shift amount corresponding to a subframe period of a least significant grayscale bit multiplied by a predetermined integral.

(2)

The image display apparatus according to (1), in which the transfer controller divides a subframe period of at least one predetermined grayscale bit in each of the groups into a plurality of periods in one frame period, distributes data of a bit plane of the predetermined grayscale bit among the plurality of periods, and transfers the data of the bit plane of the predetermined grayscale bit to the light modulator.

(3)

The image display apparatus according to (1) or (2), in which the transfer controller controls the predetermined shift amount to a value that causes transfer start timings T calculated by a following expression (1) of data of all bit planes to be different from one another and satisfies a following expression (2),

T=jΔ+2^{k}−1 (1)

Δ<(2^{q}−1)/(p−1) (2)

j=0, 1, 2, . . . , p−1

k=0, 1, 2, . . . , q−1

where Δ is an shift amount between transfer timings of the respective groups (the shift amount is Δ times the subframe period of the least significant grayscale bit), j is a number of the group, k is a bit number of the grayscale bit, p is a division number of the bit plane, and q is a number of grayscale bits.

(4)

The image display apparatus according to any one of (1) to (3), in which the transfer controller causes the division number of the bit plane to be 2 or 3, and controls the predetermined shift amount to a period that is five times the subframe period of the least significant grayscale bit.

(5)

The image display apparatus according to any one of (1) to (3), in which the transfer controller causes the division number of the bit plane to be not less than 4 and not more than 7, and controls the predetermined shift amount to a period that is nine times the subframe period of the least significant grayscale bit.

(6)

The image display apparatus according to any one of (1) to (3), in which the transfer controller causes the division number of the bit plane to be 8 or larger, and controls the predetermined shift amount to a period that is 11 times the subframe period of the least significant grayscale bit.

(7)

The image display apparatus according to any one of (1) to (6), in which the light modulator performs light modulation on each of divided display regions of which a number is equal to the division number of the bit plane.

(8)

An image display method, including:

performing light modulation by a light modulator on the basis of data of a bit plane for each grayscale bit; and

dividing the data of the bit plane into data of a plurality of groups and transferring the data of the respective groups to the light modulator at shifted transfer timings, the shifted transfer timings being sequentially shifted only by a predetermined shift amount corresponding to a subframe period of a least significant grayscale bit multiplied by a predetermined integral.

This application claims the benefit of Japanese Priority Patent Application No. 2016-090213 filed with the Japan Patent Office on Apr. 28, 2016, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An image display apparatus, comprising:
a light modulator that performs light modulation on a basis of data of a bit plane for each grayscale bit; and
a transfer controller that divides the data of the bit plane into data of a plurality of groups and transfers the data of the respective groups to the light modulator at shifted transfer timings, the shifted transfer timings being sequentially shifted only by a predetermined shift amount corresponding to a subframe period of a least significant grayscale bit multiplied by a predetermined integral.

2. The image display apparatus according to claim 1, wherein the transfer controller divides a subframe period of at least one predetermined grayscale bit in each of the groups into a plurality of periods in one frame period, distributes data of a bit plane of the predetermined grayscale bit among the plurality of periods, and transfers the data of the bit plane of the predetermined grayscale bit to the light modulator.

3. The image display apparatus according to claim 1, wherein the transfer controller controls the predetermined shift amount to a value that causes transfer start timings T calculated by a following expression (1) of data of all bit planes to be different from one another and satisfies a following expression (2),
T=jΔ+2^{k}−1 (1)
Δ<(2^{q}−1)/(p−1) (2)
j=0, 1, 2, . . . , p−1
k=0, 1, 2, . . . , q−1
where Δ is an shift amount between transfer timings of the respective groups (the shift amount is Δ times the subframe period of the least significant grayscale bit), j is a number of the group, k is a bit number of the grayscale bit, p is a division number of the bit plane, and q is a number of grayscale bits.

4. The image display apparatus according to claim 1, wherein the transfer controller causes the division number of the bit plane to be 2 or 3, and controls the predetermined shift amount to a period that is five times the subframe period of the least significant grayscale bit.

5. The image apparatus according to claim 1, wherein the transfer controller causes the division number of the bit plane to be not less than 4 and not more than 7, and controls the predetermined shift amount to a period that is nine times the subframe period of the least significant grayscale bit.

6. The image display apparatus according to claim 1, wherein the transfer controller causes the division number of the bit plane to be 8 or larger, and controls the predetermined shift amount to a period that is 11 times the subframe period of the least significant grayscale bit.

7. The image display apparatus according to claim 1, wherein the light modulator performs light modulation on each of divided display regions of which a number is equal to the division number of the bit plane.

8. An image display method, comprising:
performing light modulation by a light modulator on a basis of data of a bit plane for each grayscale bit; and
dividing the data of the bit plane into data of a plurality of groups and transferring the data of the respective groups to the light modulator at shifted transfer timings, the shifted transfer timings being sequentially shifted only by a predetermined shift amount corresponding to a subframe period of a least significant grayscale bit multiplied by a predetermined integral.
